(19) United States
(12) Patent Application Publication
(10) Pub. No.: US 2003/0018606 A1
(43) Pub. Date: Jan. 23, 2003

(54) Revocation of tokens without communication between the token holders and the token server

(75) Inventors: Marc M. Eshel, San Jose, CA (US); Frank B. Schmuck, Campbell, CA (US)

Correspondence Address: Blanche E. Schiller, Esq., HESLIN ROTHENBERG FARLEY & MESITI P.C., 5 Columbia Circle, Albany, NY, 12203, US

(73) Assignee: International Business Machines Corporation, Armonk, NY

(21) Appl. No.: 09/907,428

(22) Filed: Jul. 17, 2001

(51) Int. Cl. G06F 7/00

(52) U.S. Cl. 707/1

(57) ABSTRACT

One or more conflicting tokens are revoked using a revocation capability that eliminates the need for the holders of the conflicting tokens to communicate with the token server. Instead, information used to revoke the one or more conflicting tokens is provided by the token holders to a requester of a token that is in conflict with the conflicting tokens. The requester then forwards this information to the token server in a message already being sent to the server. Thus, additional messages between the requester and the token server are not needed.

### CROSS-REFERENCE TO RELATED PATENTS/APPLICATION

This application contains subject matter which is related to the subject matter of the following patents/application, each of which is assigned to the same assignee as this application. Each of the below listed patents/application is hereby incorporated herein by reference in its entirety:

“PARALLEL FILE SYSTEM WITH EXTENDED FILE ATTRIBUTES”, by Schmuck et al., U.S. Pat. No. 5,940,841, issued Aug. 17, 1999;

“PARALLEL FILE SYSTEM AND METHOD FOR GRANTING BYTE RANGE TOKENS”, by Schmuck et al., U.S. Pat. No. 5,950,199, issued Sep. 7, 1999;

“PARALLEL FILE SYSTEM AND METHOD FOR PARALLEL WRITE SHARING”, by Schmuck et al., U.S. Pat. No. 5,987,477, issued Nov. 16, 1999;

“PARALLEL FILE SYSTEM AND METHOD WITH BYTE RANGE API LOCKING”, by Schmuck et al., U.S. Pat. No. 5,999,976, issued Dec. 7, 1999;

“PARALLEL FILE SYSTEM WITH METHOD USING TOKENS FOR LOCKING MODES”, by Schmuck et al., U.S. Pat. No. 6,032,216, issued Feb. 29, 2000;

“DISTRIBUTED LOCK MANAGER USING A PASSIVE, STATE-FULL CONTROL-SERVER”, by Devarakonda et al., U.S. Pat. No. 5,454,108, issued Sep. 26, 1995; and

“DISTRIBUTED LOCKING PROTOCOL WITH ASYNCHRONOUS TOKEN PREFETCH AND RELINQUISH”, by Eshel et al., (POU920000145US1), Serial No. ______ , filed on _______.

### TECHNICAL FIELD

This invention relates, in general, to distributed locking, and in particular, to reducing the number of messages used to revoke tokens used for locking resources.

### BACKGROUND OF THE INVENTION

In a distributed communications environment, resources may be shared among a plurality of the nodes of the distributed environment. In order to coordinate access to the shared resources, a distributed lock manager is used. In one example, the distributed lock manager includes a layer of software that runs on each of the nodes of the environment.

The distributed lock manager uses at least one locking protocol to coordinate access to the shared resources. In one example, the locking protocol is a token-based protocol in which the distributed lock manager interfaces with a token server to obtain tokens, and then grants lock requests based on the granted tokens.

For example, when an application requests a lock of a resource, the local lock manager of the node in which the application is executing sends a request to the token server to acquire a corresponding token for the resource. Once the token is acquired, the lock manager grants the requested lock. When the lock is released, the node retains the token so that subsequent lock requests for the same object can be granted locally without requiring additional messages to the token server. The token server keeps track of which tokens are held by which nodes.

When the token server receives a request from a node for a token that is currently held by another node, the other node needs to relinquish its token before it can be granted to the requesting node. Previously, this has been accomplished by having the lock manager of the requesting node send a revoke request to the node holding the token. In response to the revoke request, the node checks whether a lock requiring the token is currently held, waits for any such lock to be released, and then sends a message to the token server to relinquish the token. The token server takes back the token and then sends an acknowledgement to the node. The node then communicates with the requesting node that the token has been revoked. The requesting node then communicates further with the token server.

Thus, it takes a number of messages to perform a revocation of a token. For example, messages are passed between the requesting node and the token server; the requesting node and the one or more holders of the conflicting tokens; and the one or more holders of the conflicting tokens and the token server. Further, the number of messages needed increases with the number of nodes holding conflicting tokens. As the number of nodes in the environment grows, so does the cost for processing a single token request by the token server. The cost increases proportionally. Moreover, as the message traffic increases, an additional burden is placed on the token server, and the token server may become a bottleneck.

Therefore, a need exists for a revocation capability that reduces the amount of message traffic to the token server. In particular, a need exists for a revocation capability that does not require communication between the one or more holders of conflicting tokens and the token server.

### SUMMARY OF THE INVENTION

The shortcomings of the prior art are overcome and additional advantages are provided through the provision of a method of revoking tokens. The method includes, for instance, determining, by a token holder of a token, that the token is to be revoked; and revoking the token using a token server, wherein the revoking is performed absent of communication between the token server and the token holder.

In a further embodiment, a method of revoking tokens is provided. The method includes, for instance, sending, by a requester of a token, one or more revoke requests to one or more token holders of one or more tokens conflicting with the token requested by the requester; receiving, by the requester, one or more replies to the one or more revoke requests, the one or more replies indicating one or more token modes for the one or more conflicting tokens to be revoked; sending, by the requester to a token server, a message indicating the one or more token modes for the one or more conflicting tokens; and updating, by the token server, state information for the one or more conflicting tokens, the updating using at least one token mode of the one or more token modes of the message.

System and computer program products corresponding to the above-summarized methods are also described and claimed herein.

Advantageously, a revocation capability is provided which eliminates the need for the one or more holders of conflicting tokens to communicate with the token server to revoke the one or more conflicting tokens. This reduces message traffic to the token server, and reduces the chances of a bottleneck at the server for token revocation.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one embodiment of a communications environment incorporating and using one or more aspects of the present invention;

FIG. 2 depicts further details of a plurality of nodes of the communications environment of FIG. 1, in accordance with an aspect of the present invention;

FIG. 3 depicts one embodiment of the flow of messages used for revoking a token, in accordance with a previous revocation protocol;

FIG. 4 depicts one embodiment of the logic associated with revoking one or more tokens, in accordance with an aspect of the present invention; and

FIG. 5 depicts one embodiment of the flow of messages used for revoking a token, in accordance with an aspect of the present invention.

### BEST MODE FOR CARRYING OUT THE INVENTION

In accordance with an aspect of the present invention, a revocation capability is provided, which reduces the amount of traffic flowing to the token server. In particular, in one embodiment, communication between one or more holders of one or more conflicting tokens (referred to herein as token holders) and the token server is eliminated during the revocation of tokens. Instead, the token holders use existing message flow, between the token holders and a requester of a token in conflict with the one or more conflicting tokens, to provide information to the requester, which is to be used to revoke the tokens. The requester then forwards this information to the token server using existing message flow, such that the token server may proceed with the revoking of the one or more conflicting tokens.

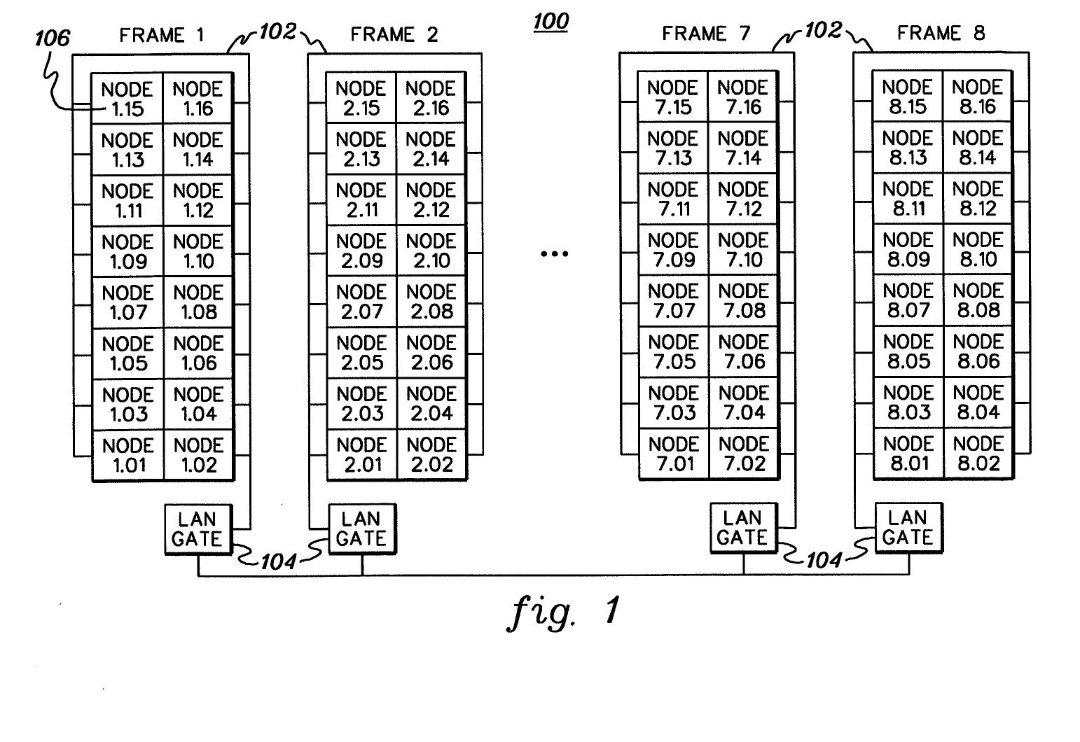

One embodiment of a communications environment incorporating and using aspects of the present invention is depicted in FIG. 1. As one example, the communications environment is a distributed computing environment 100 including, for instance, a plurality of frames 102 coupled to one another via a plurality of LAN gates 104. Frames 102 and LAN gates 104 are described in detail below.

As one example, distributed computing environment 100 includes eight frames, each of which includes a plurality of processing nodes 106. In one instance, each frame includes sixteen processing nodes (a.k.a., processors). Each processing node is, for instance, a RISC/6000 computer running AIX, a Unix based operating system. Each processing node within a frame is coupled to the other processing nodes of the frame via, for example, at least one internal LAN connection (e.g., an Ethernet; an SP switch offered by International Business Machines Corporation, Armonk, N.Y.; and/or other connections). Additionally, each frame is coupled to the other frames via LAN gates 104.

As examples, each LAN gate 104 includes either a RISC/6000 computer, any computer network connection to the LAN or a network router. However, these are only examples. It will be apparent to those skilled in the relevant art that there are other types of LAN gates and that other mechanisms can also be used to couple the frames to one another.

The distributed computing environment of FIG. 1 is only one example. It is possible to have more or less than eight frames, or more or less than sixteen nodes per frame. Further, the processing nodes do not have to be RISC/6000 computers running AIX. Some or all of the processing nodes can include different types of computers and/or different operating systems. Further, aspects of the invention are useful with other types of communications environments. All of the these variations are considered a part of the claimed invention.

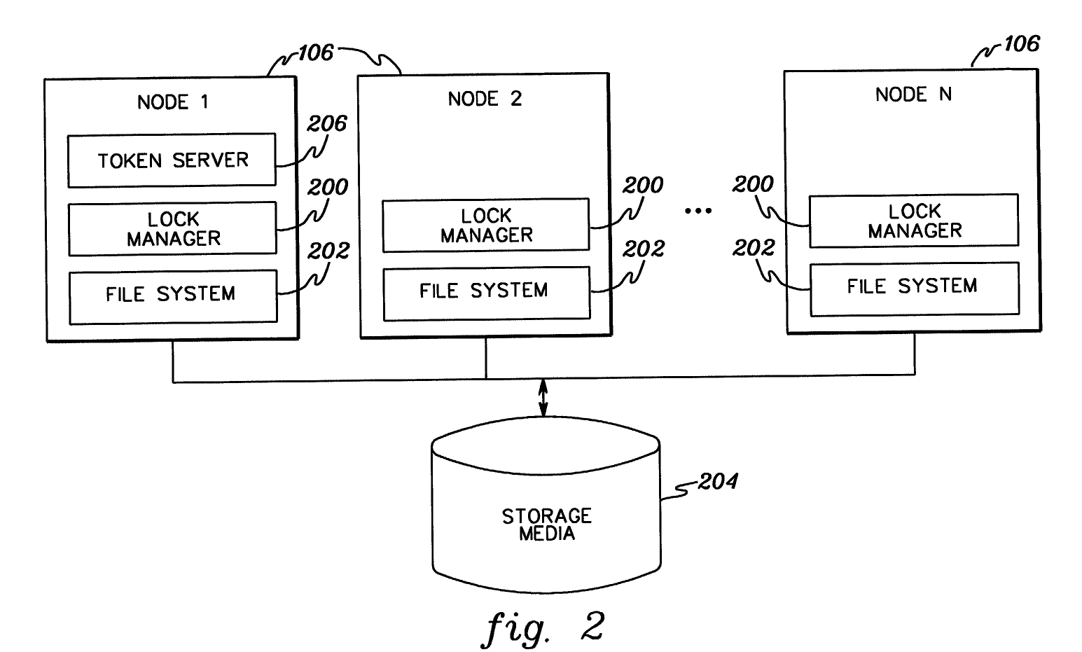

In one example, distributed across a plurality of the processing nodes of distributed computing environment 100 is a distributed lock manager 200 (FIG. 2). The distributed lock manager is responsible for coordinating access to shared resources among a set of networked processing nodes or computer systems. In particular, applications running on the processing nodes send locking requests to their local lock manager to access the shared resources. One such application is a distributed file system 202 (such as the General Parallel File System (GPFS) offered by International Business Machines Corporation). GPFS uses locking to coordinate updates to shared files stored on one more storage media 204 (e.g., disks) coupled to the nodes.

In one example, the distributed lock manager is a token-based lock manager that uses tokens to coordinate access to the shared resources. The use of the tokens is coordinated by a service executing on at least one node. This service is referred to as a token server 206.

The token server is responsible for granting tokens requested by nodes and for taking back tokens held by one or more nodes, where those nodes no longer need the tokens or the tokens are needed by other nodes. The token server keeps track of the tokens held by the various nodes.

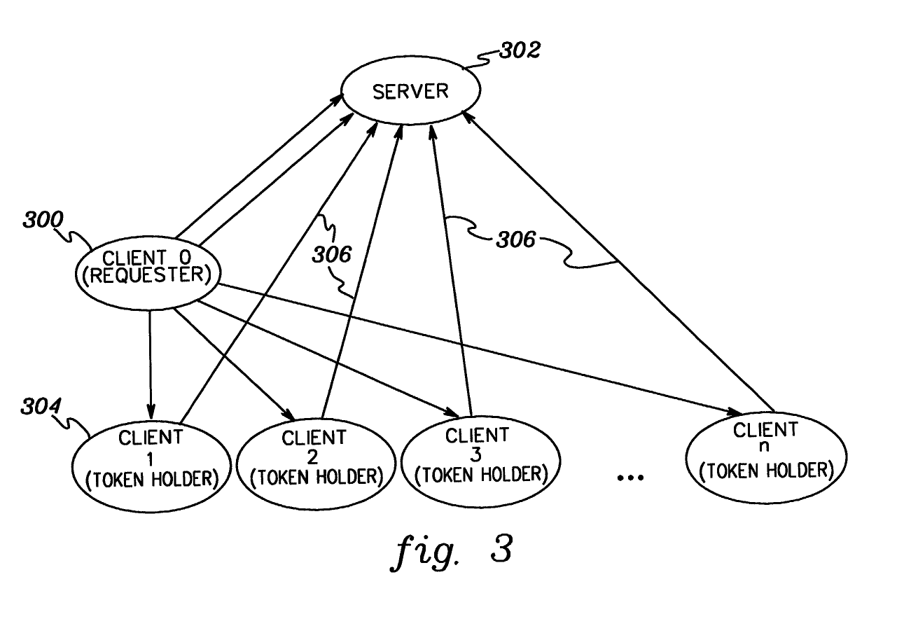

In one example, when a node requests a token, and there are one or more tokens held by one or more token holders in conflict with that token, then the one or more conflicting tokens are to be revoked from the one or more token holders. Previously, a revocation protocol was used that required messages to be sent between the node requesting the token (e.g., the requester) and the token server; the requester and the one or more token holders; and the one or more token holders and the token server. This communication is depicted in FIG. 3, in which each line with an arrow represents a message/reply pair.

Referring to FIG. 3, previously, when a requester 300 requested a token from a token server 302, the token server determined whether there were any conflicting tokens. If there were conflicting tokens, then the token server did not grant the requested token at that time, but instead, returned to the requester a list of one or more token holders 304 holding one or more conflicting tokens.

In turn, requester 300 sent a token revoke message to each token holder in the list of token holders. Each recipient of the revoke message then gave up or downgraded its token by sending a relinquish message to the token server (see communication lines 306). The relinquish message indicated the mode to which the token was to be downgraded. The token server then processed the relinquish messages and sent an acknowledgement to each of the token holders. Each token holder then replied to the revoke request sent by the requester indicating a successful completion of the revoke request. The requester waited for these replies, and then sent another message to the token server again requesting the grant of a token. When the token server received this second request, it granted the requested token, assuming all conflicts had been resolved.

It can be seen from the description above that previously, in order for the token server to grant a token when there were one or more conflicting tokens, the token server had to process a number of messages. In particular, the token server had to receive and process two messages from the requester and one message from each client in the conflict list. Thus, the token server received (2+n) messages for each token acquire, where n is the number of token holders in the conflict list. As the number of clients in the communication environment grows, the cost for processing a single token request by the token server increases proportionally.

In an effort to reduce the number of messages to the token server, a revocation protocol is provided, in accordance with an aspect of the present invention, which eliminates the need for the one or more token holders to communicate (e.g., directly) with the token server to perform the revocation. In particular, in one example, the relinquish messages between the token server and the one or more token holders are eliminated. Instead, the requester collects the information used for the revocation and communicates this information to the token server via a message already being forwarded to the token server. Thus, this revocation protocol does not require additional messages between the requester and the token server, either.

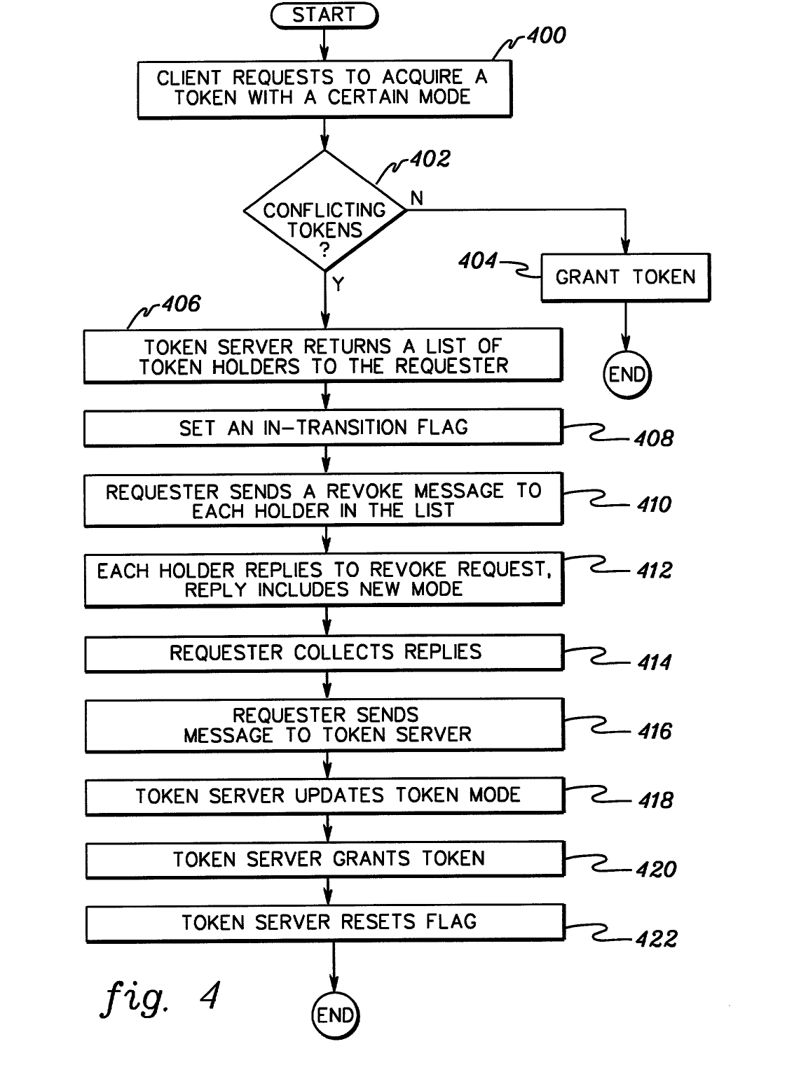

One embodiment of the logic associated with revoking tokens, in accordance with an aspect of the present invention, is depicted in FIG. 4. In one example, the logic of FIG. 4 is performed by a plurality of the nodes of the communications environment.

Referring to FIG. 4, initially a client (e.g., a requesting node) requests to acquire a token with a certain mode, STEP 400. When the token server receives the request, it determines whether there are any conflicting tokens being held by one or more other nodes, INQUIRY 402. If there are no conflicting tokens, then the token is granted, STEP 404. However, if there are one or more conflicting tokens, then the token server returns to the requester a list of one or more token holders holding the one or more conflicting tokens, STEP 406.

In addition to returning the list of conflicting tokens, the token server sets an in-transition flag, and stores the flag and an id of the requester (i.e., the revoking client) in an entry of a server token table, STEP 408. In one example, the in-transition flag is a revokePending flag, which indicates that a revocation of one or more tokens is in progress. While the revokepending flag is set, the token server blocks other acquire requests from other nodes for the same token in a conflicting mode.

In a further embodiment, a distinction may be made between asynchronous and synchronous requests. In such a case, the token server blocks any acquire requests (i.e., synchronous and asynchronous), as well as synchronous relinquish requests. The processing of asynchronous and synchronous requests, as well as a further description of the revokePending flag, are described in a co-pending U.S. Patent Application entitled “Distributed Locking Protocol With Asynchronous Token Prefetch And Relinquish”, by Eshel et al., Serial No. ______, filed on ______, which is hereby incorporated herein by reference in its entirety.

Returning to FIG. 4, subsequent to setting the in-transition flag, the requester sends a revoke message to each token holder in its list of conflicting tokens, STEP 410. Each recipient of the revoke request checks whether a lock requiring the token is currently held, waits for any such lock to be released, and then replies to the revoke request, STEP 412. Each reply includes, in accordance with an aspect of the present invention, a mode for the token to be revoked. As examples, the mode represents a downgrade of the token, which may be a lesser mode or the giving up of the token.

The requester collects the replies from the one or more token holders, STEP 414, and then sends another message to the token server requesting once again to acquire the token, STEP 416. This second message includes, in accordance with an aspect of the present invention, a collection of the replies from the one or more token holders.

The token server, in response to receiving the second message, processes the request including updating the token mode for each of the nodes in the conflict list. Assuming that each of the nodes holding conflicting tokens downgraded their token to a mode that was no longer conflicting with the requested token, the token server grants the token to the requesting node, STEP 420. Additionally, the token server resets the in-transition flag, so that other requests may be processed.

In the embodiment described above, it is assumed that each token holder revokes its conflicting token (i.e., downgrades its token). However, it is possible that a token holder does not provide a mode that indicates revocation (i.e., a lesser mode or giving up) of the token. It is also possible that one or more of the token holders do not reply. In those cases, the revocation is considered unsuccessful, and the token server does not grant the token to the requester.

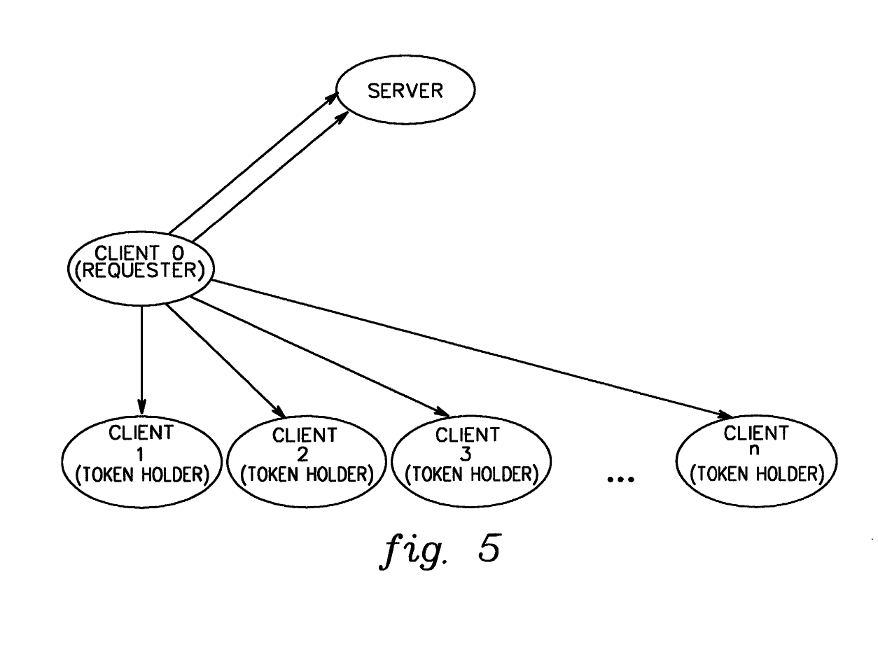

The revocation protocol of an aspect of the present invention advantageously reduces the number of messages to the token server. In one example, the number of messages are reduced from 2+n to 2 by eliminating the need for relinquish messages to revoke a token. This reduction in messages is pictorially depicted in FIG. 5, in which no communication is shown between the token holders and the token server for the revocation protocol.

The saving of message traffic realized by an aspect of the present invention is demonstrated in the following table, in which OLD represents a previous revocation protocol and NEW represents the revocation protocol of an aspect of the present invention:

| NUMBER OF MESSAGES | OLD | NEW |
|---|---|---|
| NUMBER OF MESSAGES TO THE TOKEN SERVER | 2 + n | 2 |
| (SERVER LOAD) | | |
| TOTAL NUMBER OF MESSAGES | 2 + 2n | 2 + n |
| (NETWORK LOAD) | | |
| NUMBER OF MESSAGE DELAYS | 4 | 3 |
| (RESPONSE TIME) | | |

The above analysis shows that the revocation protocol of an aspect of the present invention improves scalability by reducing the load on the server and making it independent of the number of nodes holding conflicting tokens. The technique of an aspect of the present invention reduces overall network load by reducing the number of messages by roughly one-half. The revocation protocol of an aspect of the present invention improves response time by reducing the number of message delays required to obtain a token.

In one embodiment, the correctness of the revocation protocol of an aspect of the present invention is based on the fact that the token server blocks new token requests, while the in-transition flag is set. By setting the flag, none of the clients that are holding conflicting tokens (e.g., token holders 1−n) are able to reacquire the token being revoked, during a time window between their reply to the revoke requests and the time that the token server processes their token updates, when it receives the second request from the requesting client.

Notwithstanding the foregoing, in one embodiment, the token server may apply to the token state of any of token holders 1−n, in this time window, a voluntary relinquish that downgrades the token state to a mode that is even weaker than the mode that was sent in the reply to the revoke request. To allow for this possibility, in accordance with an aspect of the present invention, the token server processes the token state updates received in the second message from the requesting node by setting the token mode of each of token holders 1−n to the minimum (i.e., the weaker) of the currently recorded mode and the mode that was received in the message. This ensures that after processing the second message from the requesting node, the token state at the server is the same as it would be under the previous protocols, despite the fact that the token mode update due to the token revoke and the token mode update due to a voluntary relinquish are processed in a different order.

Described in detail above is an embodiment of a revocation protocol, which eliminates the need for communications between the token server and the one or more holders of tokens to be revoked. Advantageously, this reduces the burden on the token server, by reducing the number of messages to be handled by the token server.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of revoking tokens, said method comprising:
determining, by a token holder of a token, that the token is to be revoked; and
revoking the token using a token server, wherein the revoking is performed absent of communication between the token server and the token holder.

2. The method of claim 1, wherein the determining comprises receiving a revoke request requesting that the token be revoked.

3. The method of claim 2, wherein the revoke request is from a requester, and wherein the revoking comprises:
providing, by the token holder to the requester, information to be used in the revoking of the token; and
forwarding from the requester to the token server the information to be used in the revoking.

4. The method of claim 3, wherein the information includes a token mode for the token.

5. The method of claim 4, wherein the token mode represents a downgrade of the token.

6. The method of claim 5, wherein the revoking further comprises updating a state of the token to reflect the downgraded token mode.

7. The method of claim 3, wherein the revoke request is sent from the requester to the token holder in response to an indication that the token to be revoked is in conflict with a requested token of the requester.

8. The method of claim 7, wherein the forwarding comprises sending a message to the token server requesting to acquire the requested token, said message including the information.

9. The method of claim 3, wherein the revoking further comprises updating, by the token server, a state of the token, said updating using the information.

10. The method of claim 2, further comprising sending the revoke request from a requester of a requested token to the token holder, wherein the revoke request is in response to an indication that the token to be revoked in is in conflict with the requested token.

11. The method of claim 10, wherein the indication is received by the requester from the token server, in response to a request from the requester for the requested token.

12. The method of claim 1, wherein the determining comprises determining by one or more token holders of one or more tokens that one or more tokens are to be revoked, and wherein the revoking comprises revoking the one or more tokens to be revoked.

13. The method of claim 1, wherein the absence of communication comprises passing no messages for the revoking between the token server and the token holder.

14. A method of revoking tokens, said method comprising:
sending, by a requester of a token, one or more revoke requests to one or more token holders of one or more tokens conflicting with the token requested by the requester;
receiving, by the requester, one or more replies to the one or more revoke requests, the one or more replies indicating one or more token modes for the one or more conflicting tokens to be revoked;
sending, by the requester to a token server, a message indicating the one or more token modes for the one or more conflicting tokens; and
updating, by the token server, state information for the one or more conflicting tokens, said updating using at least one token mode of the one or more token modes of the message.

15. The method of claim 14, wherein one or more separate relinquish requests from the one or more token holders to the token server are not needed to revoke the one or more conflicting tokens.

16. The method of claim 14, further comprising receiving, by the requester from the token server, an indication of the one or more token holders of the one or more tokens conflicting with the token requested by the requester.

17. The method of claim 16, wherein the receiving from the token server is in response to a request from the requester for the token.

18. The method of claim 14, wherein the updating is performed absent communication between the token server and the one or more token holders.

19. A system of revoking tokens, said system comprising:
means for determining, by a token holder of a token, that the token is to be revoked; and
means for revoking the token using a token server, wherein the revoking is performed absent of communication between the token server and the token holder.

20. The system of claim 19, wherein the means for determining comprises means for receiving a revoke request requesting that the token be revoked.

21. The system of claim 20, wherein the revoke request is from a requester, and wherein the means for revoking comprises:
means for providing, by the token holder to the requester, information to be used in the revoking of the token; and
means for forwarding from the requester to the token server the information to be used in the revoking.

22. The system of claim 21, wherein the information includes a token mode for the token.

23. The system of claim 22, wherein the token mode represents a downgrade of the token.

24. The system of claim 23, wherein the means for revoking further comprises means for updating a state of the token to reflect the downgraded token mode.

25. The system of claim 21, wherein the revoke request is sent from the requester to the token holder in response to an indication that the token to be revoked is in conflict with a requested token of the requester.

26. The system of claim 25, wherein the means for forwarding comprises means for sending a message to the token server requesting to acquire the requested token, said message including the information.

27. The system of claim 21, wherein the means for revoking further comprises means for updating, by the token server, a state of the token, said updating using the information.

28. The system of claim 20, further comprising means for sending the revoke request from a requester of a requested token to the token holder, wherein the revoke request is in response to an indication that the token to be revoked in is in conflict with the requested token.

29. The system of claim 28, wherein the indication is received by the requester from the token server, in response to a request from the requester for the requested token.

30. The system of claim 19, wherein the means for determining comprises means for determining by one or more token holders of one or more tokens that one or more tokens are to be revoked, and wherein the means for revoking comprises means for revoking the one or more tokens to be revoked.

31. The system of claim 19, wherein the absence of communication comprises passing no messages for the revoking between the token server and the token holder.

32. A system of revoking tokens, said system comprising:
means for sending, by a requester of a token, one or more revoke requests to one or more token holders of one or more tokens conflicting with the token requested by the requester;
means for receiving, by the requester, one or more replies to the one or more revoke requests, the one or more replies indicating one or more token modes for the one or more conflicting tokens to be revoked;
means for sending, by the requester to a token server, a message indicating the one or more token modes for the one or more conflicting tokens; and
means for updating, by the token server, state information for the one or more conflicting tokens, said means for updating comprising means for using at least one token mode of the one or more token modes of the message.

33. The system of claim 32, wherein one or more separate relinquish requests from the one or more token holders to the token server are not needed to revoke the one or more conflicting tokens.

34. The system of claim 32, further comprising means for receiving, by the requester from the token server, an indication of the one or more token holders of the one or more tokens conflicting with the token requested by the requester.

35. The system of claim 34, wherein the receiving from the token server is in response to a request from the requester for the token.

36. The system of claim 32, wherein the means for updating is absent communication between the token server and the one or more token holders.

37. A system of revoking tokens, said system comprising:
a token holder of a token adapted to determine that the token is to be revoked; and
a token server used in revoking the token, wherein the revoking is performed absent of communication between the token server and the token holder.

38. A system of revoking tokens, said system comprising:
a requester of a token, said requester adapted to:
send one or more revoke requests to one or more token holders of one or more tokens conflicting with the token requested by the requester;
receive one or more replies to the one or more revoke requests, the one or more replies indicating one or more token modes for the one or more conflicting tokens to be revoked;
send to a token server a message indicating the one or more token modes for the one or more conflicting tokens; and
the token server to update state information for the one or more conflicting tokens, the updating using at least one token mode of the one or more token modes of the message.

39. At least one program storage device readable by a machine, tangibly embodying at least one program of instructions executable by the machine to perform a method of revoking tokens, said method comprising:
determining, by a token holder of a token, that the token is to be revoked; and
revoking the token using a token server, wherein the revoking is performed absent of communication between the token server and the token holder.

40. The at least one program storage device of claim 39, wherein the determining comprises receiving a revoke request requesting that the token be revoked.

41. The at least one program storage device of claim 40, wherein the revoke request is from a requester, and wherein the revoking comprises:
providing, by the token holder to the requester, information to be used in the revoking of the token; and
forwarding from the requester to the token server the information to be used in the revoking.

42. The at least one program storage device of claim 41, wherein the information includes a token mode for the token.

43. The at least one program storage device of claim 42, wherein the token mode represents a downgrade of the token.

44. The at least one program storage device of claim 43, wherein said revoking further comprises updating a state of the token to reflect the downgraded token mode.

45. The at least one program storage device of claim 41, wherein the revoke request is sent from the requester to the token holder in response to an indication that the token to be revoked is in conflict with a requested token of the requester.

46. The at least one program storage device of claim 45, wherein the forwarding comprises sending a message to the token server requesting to acquire the requested token, said message including the information.

47. The at least one program storage device of claim 41, wherein said revoking further comprises updating, by the token server, a state of the token, said updating using the information.

48. The at least one program storage device of claim 40, wherein said method further comprises sending the revoke request from a requester of a requested token to the token holder, wherein the revoke request is in response to an indication that the token to be revoked in is in conflict with the requested token.

49. The at least one program storage device of claim 48, wherein the indication is received by the requester from the token server, in response to a request from the requester for the requested token.

50. The at least one program storage device of claim 39, wherein the determining comprises determining by one or more token holders of one or more tokens that one or more tokens are to be revoked, and wherein the revoking comprises revoking the one or more tokens to be revoked.

51. The at least one program storage device of claim 39, wherein the absence of communication comprises passing no messages for the revoking between the token server and the token holder.

52. At least one program storage device readable by a machine, tangibly embodying at least one program of instructions executable by the machine to perform a method of revoking tokens, said method comprising:
sending, by a requester of a token, one or more revoke requests to one or more token holders of one or more tokens conflicting with the token requested by the requester;
receiving, by the requester, one or more replies to the one or more revoke requests, the one or more replies indicating one or more token modes for the one or more conflicting tokens to be revoked;
sending, by the requester to a token server, a message indicating the one or more token modes for the one or more conflicting tokens; and
updating, by the token server, state information for the one or more conflicting tokens, said updating using at least one token mode of the one or more token modes of the message.

53. The at least one program storage device of claim 52, wherein one or more separate relinquish requests from the one or more token holders to the token server are not needed to revoke the one or more conflicting tokens.

54. The at least one program storage device of claim 52, wherein said method further comprises receiving, by the requester from the token server, an indication of the one or more token holders of the one or more tokens conflicting with the token requested by the requester.

55. The at least one program storage device of claim 54, wherein the receiving from the token server is in response to a request from the requester for the token.

56. The at least one program storage device of claim 52, wherein the updating is performed absent communication between the token server and the one or more token holders.
